(19) United States
(12) Patent Application Publication
(10) Pub. No.: US 2026/0285273 A1
(43) Pub. Date: Sep. 24, 2026

(54) ELECTROMECHANICAL BRAKING SYSTEM FOR A MOTOR VEHICLE AND METHOD FOR OPERATING AN ELECTROMECHANICAL BRAKING SYSTEM IN A MOTOR VEHICLE

(71) Applicants: thyssenkrupp Presta AG, Eschen (LI); thyssenkrupp AG, Essen (DE)

(72) Inventor: Gabor ORDASI, Diosd (HU)

(73) Assignees: thyssenkrupp Presta AG, Eschen (LI); thyssenkrupp AG, Essen (DE)

(21) Appl. No.: 19/167,315

(22) PCT Filed: Oct. 24, 2023
(86) PCT No.: PCT/EP2023/079614

§ 371 Date: Sep. 19, 2025

(30) Foreign Application Priority Data
Mar. 22, 2023 (DE) 10 2023 107 227.7

(51) Int. Cl. B60T 8/88; B60T 8/32; B60T 8/96; B60T 13/74; F16D 65/18; F16D 66/00; F16D 121/24

(52) U.S. Cl. CPC B60T 8/885; B60T 8/3255; B60T 8/96; B60T 13/746; F16D 65/18; B60T 2220/04; B60T 2240/00; B60T 2270/402; B60T 2270/404; B60T 2270/413; B60T 2270/416; B60T 2270/82; F16D 2066/003; F16D 2066/006; F16D 2121/24

(57) ABSTRACT

A method for operating an electromechanical brake system in a motor vehicle, wherein the brake system has at least one input unit, via which a brake demand is transmitted, and at least two brake apparatuses which each comprise a brake actuator with at least one electric actuating motor, wherein the brake apparatuses are each assigned a wheel brake control unit and a wheel speed sensor unit, comprises providing, by the associated wheel speed sensor unit of the associated wheel brake control unit, a wheel speed for a respective brake apparatus, providing a substitute wheel speed for the wheel speed which is provided by the associated wheel speed sensor unit to this wheel brake control unit, actuating, by this wheel brake control unit, the brake actuator in normal operation in order to implement the transmitted brake demand, with consideration of the wheel speed which is provided by the associated wheel speed sensor unit, and actuating, by the wheel brake control unit, the brake actuator with consideration of the provided substitute wheel speed in order to implement the transmitted brake demand in the case of a disruption in relation to the provision of the wheel speed by the associated wheel speed sensor unit. A brake system is configured to be operated in accordance with a method of this type.

The invention relates to an electromechanical brake system for a motor vehicle, comprising at least one input apparatus for transmitting a brake demand, at least two brake apparatuses which are each assigned a wheel speed sensor unit which is configured to provide a wheel speed to the associated brake apparatus, wherein the brake apparatuses each comprise a brake actuator which has at least one electric actuating motor. Furthermore, the invention relates to a method for operating an electromechanical brake system in a motor vehicle, wherein the brake system has at least one input unit, via which a brake demand is transmitted, and at least two brake apparatuses which each comprise a brake actuator with at least one electric actuating motor.

A brake system of this type comprises at least two electric-motor brake apparatuses which are each assigned to a wheel to be braked of a motor vehicle. This is therefore also called a brake unit or wheel brake. An electric-motor brake apparatus has an electric-motor brake actuator which is supported on the chassis of a motor vehicle relative to the rotation of the wheel to be braked and has at least one electric actuating motor. The latter acts via an actuating apparatus on a brake part, for example a brake lining, which can be brought into brake engagement, by rotating driving of the actuating motor, with a counterbrake part which is attached to the wheel to be braked, for example a brake disk. In brake engagement, a frictional contact is generated between the brake part and the counterbrake part, wherein the brake torque which is generated by friction becomes greater the higher the adjusting force which is exerted in the adjusting direction by the actuating apparatus. Brake systems of this type are known in the prior art, for example, from DE 10 2017 123 266A1, U.S. Pat. No. 6,397,981 B1 or U.S. Pat. No. 6,081,081 A. In accordance with the disclosure of U.S. Pat. No. 6,081,081 A, each brake actuator can be actuated individually by the central control unit. As a result, it is possible for each brake apparatus to be activated separately in order to optimize the brake action.

The actuation of the brake system takes place electrically. A brake demand, in particular an electric brake command, for initiating a brake operation can be generated manually by an input unit, in particular a brake pedal or a parking brake switch, and, in addition or as an alternative, by an automated input unit, in particular an antilock brake system (also ABS for short) or an automatic drive system (also ADS for short). With consideration of a brake demand of this type, the actuating motors of the brake actuators can be actuated, and brake apparatuses can be brought into brake engagement.

The optimum brake torque, by way of which a brake distance which is as short as possible, as far as possible without locking of the wheels, can be realized, can be determined from the setpoint values output by way of the brake demand and further actual parameters which are relevant for the brake operation, in particular wheel position, wheel speed, electric current of the actuating motor, brake force, vehicle speed and/or further actual parameters. It is known in the prior art, for example, from U.S. Pat. No. 6,317,675 B1 for at least the values for the brake demand and possibly further values to be provided to a central control unit which can also synonymously be called an ECU (Electronic Control Unit). In accordance with a predefined control algorithm, this control unit determines the control currents which are required for the actuating motors of all brake actuators and are required for the generation of determined wheel brake torques. Here, the wheel speed is an actual parameter with a special meaning, which should always be provided in order to convert the brake demand into a corresponding brake engagement of the respective brake apparatus, in order to prevent a brake failure, even a partial brake failure. In order to increase the reliability, U.S. Pat. No. 6,410,993 B1 discloses a circuit arrangement of dual-circuit or multiple-circuit construction for a safety-critical control system, such as brake-by-wire, wherein each circuit of the circuit arrangement contains a complete microprocessor system which processes the input data in a redundant manner and supplies a fault recognition signal (FAIL) if a fault or a discrepancy between the data processing results which are generated in a redundant manner occurs.

Against this background, it is an object of the present invention to provide an improved electromechanical brake system and an improved method for operating an electromechanical brake system, wherein the reliability is advantageously increased and, in particular, the reliability of the provision of a wheel speed is improved in an inexpensive way.

In order to achieve this object, a method for operating an electromechanical brake system in a motor vehicle and an electromechanical brake system as claimed in the independent claims are proposed. Further advantageous refinements of the invention are described in the dependent claims and the description, and are shown in the figures.

The proposed solution provides a method for operating an electromechanical brake system in a motor vehicle, wherein the brake system has at least one input unit, via which a brake demand is transmitted, and at least two brake apparatuses which each comprise a brake actuator with at least one electric actuating motor, wherein the brake apparatuses are each assigned a wheel brake control unit and a wheel speed sensor unit. The associated wheel speed sensor unit of the associated wheel brake control unit provides a wheel speed for a respective brake apparatus, and a substitute wheel speed for the wheel speed which is provided by the associated wheel speed sensor unit is provided to this wheel brake control unit. According to the invention, this wheel brake control unit actuates the brake actuator in normal operation in order to implement the transmitted brake demand, with consideration of the wheel speed which is provided by the associated wheel speed sensor unit, and this wheel brake control unit actuates the brake actuator with consideration of the provided substitute wheel speed in the case of a disruption in relation to the provision of the wheel speed by the associated wheel speed sensor unit. It is provided here, in particular, that the substitute wheel speed is not determined by way of the wheel speed sensor unit which is assigned to the relevant wheel and preferably also not by way of a redundant wheel speed sensor unit which is of identical configuration and is assigned to the relevant wheel. In this respect, although the substitute wheel speed is, in particular, a parameter which approximates the actual wheel speed of a wheel and, in particular, can coincide with the latter, certain deviations from the actual wheel speed can certainly be accepted, in particular, in relation to it. The brake actuator can advantageously be controlled further as a result, in particular in relation to the corresponding control algorithm without a deviation from normal operation, by the substitute wheel speed for the relevant wheel advantageously being used as parameter in the case of a disruption instead of the wheel speed of the relevant wheel. Here, in accordance with one refinement, the substitute wheel speed can be provided only when a disruption has occurred. However, it is provided, in particular, that the substitute wheel speed is determined and provided for each wheel even in disruption-free normal operation. Further advantageously, with utilization of the substitute wheel speed in normal operation, a diagnosis, in particular a plausibility check, is carried out in relation to the wheel speed which is provided by the associated wheel speed sensor unit. In this way, a problem with regard to one of the wheel speed sensor unit and/or with regard to the determination of the substitute wheel speed can advantageously be detected at an early stage.

It is provided in accordance with one advantageous refinement that the wheel brake control units are connected to one another via a data transmission system, in particular a communications bus, further particularly a CANbus, for the exchange of data. A wheel speed is advantageously provided as substitute wheel speed via the data transmission system to the wheel brake control unit, which is assigned to a brake apparatus, by at least one of the wheel speed sensor units which is not assigned to this brake apparatus. In this respect, the substitute wheel speed is in this case a wheel speed which is measured at a different wheel. In the case of a four-wheeled motor vehicle, in this respect, the wheel speeds of the further wheels are provided as substitute wheel speed, in particular, to a first brake apparatus which is assigned to a wheel. Here, in particular, processing and weighting of the three wheel speeds for the three further wheels is also provided in a manner dependent on current driving parameters, wherein a computationally determined substitute wheel speed is determined from the three wheel speeds detected by sensor for this first brake apparatus. A failure of the detection by sensor of a wheel speed for a first wheel is therefore advantageously compensated for in this refinement by a detection of the wheel speed of the further wheels of the motor vehicle.

A further advantageous refinement provides that the input unit of the brake system is connected to the respective wheel brake control units via a communications link in order to transmit the brake demand, wherein, as substitute wheel speed, the wheel speed which is provided by one of the further wheel brake control units is provided via the communications link by this wheel brake control unit to the wheel brake control unit which is assigned to a brake apparatus. The communications link between the input unit of the brake system and the wheel brake control unit is advantageously not realized here via a communications bus, with the result that, in particular in the case of a disruption of the communications bus which prevents a wheel speed being provided by the further wheel brake control units via the communications bus to a first wheel brake control unit, a provision of the wheel speed as substitute wheel speed can nevertheless take place via the communications link. It is provided, in particular, that the communications link between the input unit and the respective wheel brake control unit is a line cable, preferably a sensor cable.

The brake demand is advantageously transmitted in a first frequency range via the communications link, and the substitute wheel speed is transmitted in a second frequency range via the communications link, wherein the second frequency range is a frequency range which differs from the first frequency range. In particular, the first frequency range is in a 1 kHz range, and the second frequency ranges in a 100 kHz range. In particular, the first frequency range and the second frequency range lie so far apart from one another that the signal for the brake demand and the signal for the substitute wheel speed do not interfere with one another. The brake demand is preferably transmitted as a first signal via the communications link to the wheel brake control units, and the substitute wheel speed is transmitted via the communications link as a second signal which is modulated onto the first signal, wherein the first signal is transmitted, in particular, in the first frequency range, and the second signal is transmitted, in particular, in the second frequency range. The respective wheel brake control unit which provides the substitute wheel speed advantageously modulates the substitute wheel speed as the second signal, and the receiving wheel brake control unit demodulates the second signal. Further advantageously, the input unit of the brake system is a brake pedal or a brake pedal sensor which is included by the brake pedal and transmits a brake pedal position in an analog or digital manner as a brake demand, wherein the transmission of the substitute wheel speed as second signal takes place, in particular, via sensor cables as communications link which lead from the brake pedal sensor to the wheel brake control units. In this respect, each wheel brake control unit advantageously has a galvanic link to the input unit, in particular to the brake pedal sensor. This brake pedal sensor preferably automatically transmits the information with regard to a brake demand via the pedal position. The brake pedal sensor can be an analog or digital sensor. Here, each wheel brake control unit preferably has a receiver interface which receives the brake demand from the brake pedal sensor as first signal. Furthermore, the receiver interface is advantageously configured to feed a signal into the communications link which can be formed, in particular, by the pedal sensor line, preferably by modulation. The wheel brake control units can advantageously exchange information with other control units by means of this modulation and can thus, in particular, transmit a wheel speed. For the case where a wheel brake control unit does not receive any information with regard to a current wheel speed from the associated wheel speed sensor, for example because the cable or the sensor is defective, the wheel brake control unit can advantageously ask the other wheel brake control units for their wheel speed via the data transmission system which can be configured, in particular, as a CANbus, and can receive this wheel speed provided as substitute wheel speed, or this wheel brake control unit can advantageously receive the signal via the communications link, in particular the cable of the brake pedal sensor, and can decode the modulated signal which comes from the further wheel brake control units, in order thus to arrive at the substitute wheel speed. In this respect, a substitute wheel speed can advantageously be provided to a wheel brake control unit via the communications link between wheel brake control units and the input unit even in the case of a disruption in relation to the data transmission system.

It is provided in accordance with a further advantageous refinement that at least one of the brake apparatuses comprises a brake disk, wherein the wheel brake control units which are assigned to a brake apparatus of this type with a brake disk determine the substitute wheel speed or a further substitute wheel speed based on vibrations of the brake disk. It is therefore provided, in particular, that, in accordance with this refinement, a substitute wheel speed is determined for the relevant wheel in addition or as an alternative, wherein the substitute wheel speed is not determined by one of the wheel speed sensor units. Instead, the fact is advantageously utilized that a speed of the associated wheel can be extrapolated via a vibration of the brake disk.

Here, the wheel brake control unit which is assigned to a brake apparatus with a brake disk advantageously detects a ripple current which is brought about on account of mechanical coupling in the at least one actuating motor of the brake apparatus, and determines the substitute wheel speed or the further substitute wheel speed based on the detected ripple current. The fact is advantageously utilized that a small spacing between the brake disk and the brake linings couples the mechanical movement to the actuating motor, in particular via the brake lining, brake piston, slide, motor shaft, motor, and current brought about in the motor. The vibration brings about a ripple of the motor current, that is to say a ripple current. Since the wheel brake control unit which is assigned to the actuating motor measures, in particular, the motor current, it is advantageously provided that the wheel brake control unit measures and evaluates the ripple factor of the current. The wheel speed is advantageously estimated by the wheel brake control unit on the basis of the ripple frequency.

It is further advantageously provided that, during normal operation, an artificial intelligence (Al) system, in particular an artificial intelligence system of the wheel brake control unit or an artificial intelligence system of a superordinate motor vehicle control unit, trains the determination of the substitute wheel speed or the further substitute wheel speed based on the ripple current detected for a brake apparatus, with consideration of the wheel speed which is provided by the wheel speed sensor unit which is assigned to this brake apparatus. The assignment of a vibration to a wheel speed is advantageously improved in this way. The substitute wheel speed is advantageously approximated to an actual wheel speed in an improved manner in this way.

A further advantageous refinement of the method provides that the brake apparatuses are connected to a central control unit which is configured for connection to the at least one input unit, wherein a brake demand is input by at least one of the input units into the central control unit which actuates the brake actuators by way of control signals, wherein the central control unit outputs control signals to at least two wheel brake control units which are each assigned to a brake apparatus and each actuate a brake actuator of the respective brake apparatus. It is one advantage of the method which is configured in this way that improved reliability can be achieved by the decentralized control architecture, in particular by the robust embodiment which is less sensitive to external interference factors, and the possibility of the redundant distribution of control functions to the central control unit and the wheel brake control units. In particular, an antilock brake system (ABS) control operation can take place decentrally and independently of the central control unit by the wheel brake control unit together with the associated wheel speed sensor unit. As a result, further increased reliability can be realized.

It is advantageous that actual signals are transmitted to each of the wheel brake control units by a wheel speed sensor unit of the respective brake apparatus. In accordance with a control stipulation, the actuation of the respective brake actuator is regulated in the respective wheel brake control unit with consideration of the actual signals of the wheel speed sensor units such as, in particular, wheel position and/or wheel speed, with the result that the setpoint values which are predetermined by the brake command are realized. The wheel speed sensor unit preferably provides the actual signals of the measured parameters in real time. Actual values which are provided by further sensor apparatuses can also be considered and processed, in particular electric current of the actuating motor, brake force and/or vehicle speed. It is a further advantage of the method that the processing of the signals supplied by the wheel speed sensor (wheel position sensor) can take place practically in real-time in the decentral wheel brake control units of the brake apparatuses. As a result, an increased processing speed and reliability and a redundant design of the controller can be realized.

Furthermore, it is provided in accordance with one advantageous refinement that the brake apparatus has an actuating apparatus which can be coupled to the at least one actuating motor and comprises a first actuating drive and a second actuating drive which is connected in series to the former, and which acts on a brake part which can be brought into brake engagement with a counterbrake part in the direction of an axis, wherein the first actuating drive has a rotationally drivable first drive wheel, to which a first drive torque can be applied for actuation purposes, and the second actuating drive has a rotationally drivable second drive wheel which is coaxial with respect to the first drive wheel and to which a second drive torque can be applied for actuation purposes, wherein a clutch apparatus is arranged between the first drive wheel and the second drive wheel. The clutch apparatus is preferably configured as a friction clutch and has a predefinable clutch torque, upon the exceeding of which the first drive wheel slips in a sliding manner relative to the second drive wheel, wherein the first drive wheel and the second drive wheel are driven synchronously in order to actuate the first actuating drive, with the result that the second actuating drive remains non-actuated, and, in order to actuate the second actuating drive, the second drive wheel is driven, and the first drive wheel is at a standstill relative to the former, with the result that the friction clutch slips and the first actuating drive remains non-actuated. In order to adjust the first actuating drive, an actuating torque can be coupled into the first drive wheel by means of a first electric actuating motor, and the second actuating drive can correspondingly be driven by a second electric actuating motor.

In normal brake operation, the first and the second drive wheel are advantageously rotated synchronously. This can take place firstly by virtue of the fact that the first and second drive wheel are driven by the first and second actuating motors with synchronized drive torques. Secondly, the second drive wheel can be driven synchronously by the clutch apparatus during driving of the first drive wheel, as long as the transmitted drive torque remains below the clutch torque. In this operating mode, the second actuating drive advantageously remains non-actuated, and rotates in its entirety in an idling manner together with the brake element. In this design variant with the friction clutch, the clutch apparatus can slip in a continuously and uniformly sliding manner if the clutch torque is exceeded in order to adjust the air gap between the brake part and the counterbrake part. This can be realized, in particular, by virtue of the fact that the drive wheel of the first actuating drive is fixed, in particular by a brake or a corresponding actuation of the first drive motor, while a second drive torque is applied to the second drive wheel by the second drive motor, which second drive torque is greater than the clutch torque. As a result, the second drive wheel is rotated relative to the first drive wheel, and the air gap can be adjusted continuously and precisely by actuation of the second actuating drive, with the result that continuously advancing wear of the brake element or the brake lining can be compensated for in an optimum manner.

It is advantageous that the first drive wheel and the second drive wheel are coupled in a torque-transmitting manner by the friction clutch in order to generate a synchronous drive. No synchronous driving of the two drive wheels by the actuating motors is required here. Possible torque differences can be compensated for within predefined tolerances.

It can advantageously be provided that a higher clutch torque is predefined during the actuation of the first actuating drive than during the actuation of the second actuating drive. The first actuating drive is actuated by synchronous driving of the first and the second drive wheel. The friction element and the counterfriction element are preloaded against one another by the spring force of the spring element, and the adjusting force of the first actuating drive additionally acts counter to the spring force. A relatively high clutch torque is realized as a result. If, in contrast, only the second drive wheel is rotated for adjusting the air gap, only the spring force is active, with the result that a lower clutch torque is set. The adjustment of the air gap is facilitated as a result.

The brake system, proposed in the further text for achieving the object stated at the outset, for a motor vehicle comprises at least one input apparatus for transmitting a brake demand, at least two brake apparatuses which are each assigned a wheel speed sensor unit which is configured to provide a wheel speed to the associated brake apparatus, wherein the brake apparatuses each comprise a brake actuator which has at least one electric actuating motor. The brake apparatuses are each assigned a wheel brake control unit for controlling the respective brake actuator, wherein the wheel brake control unit is configured to control the brake actuator with consideration of the wheel speed which is provided by the associated wheel speed sensor unit, and is configured, furthermore, to control the brake actuator with consideration of a substitute wheel speed for the wheel speed which is provided by the associated wheel speed sensor unit. In this regard, the control operation can advantageously continue to take place in the case of a disruption in relation to the provision of the wheel speed, to be precise then with their substitute wheel speed instead of the wheel speed. In this way, the reliability is increased in an inexpensive manner. The brake system is particularly advantageously configured for operation in accordance with a method configured according to the invention.

A further advantageous refinement of the brake system provides that the brake apparatuses are connected to a central control unit which is configured for connection to the at least one input unit, and the wheel brake control units are connected to the central control unit.

A brake apparatus which can also synonymously be called a brake unit wheel brake is assigned to in each case one wheel of the vehicle. Each brake apparatus has a brake actuator with at least one electric actuating motor which can exert an adjusting force on the brake part, in particular a brake lining, via an actuating apparatus. As a result, the brake part can be brought into brake engagement with a counterbrake part, in particular a brake disk, which is assigned to the wheel. The brake apparatuses can be activated by input units which can have manual input apparatuses such as a brake pedal or a parking brake switch, and, in addition or as an alternative, automated input units such as an antilock brake system (ABS) or an automatic drive system (ADS). The input units are advantageously connected electrically to the central control unit. The central control unit is configured, in particular, as an ECU (Electronic Control Unit).

The brake system advantageously has at least two wheel brake control units which are separate from the central control unit. They can be actuated electrically by the central control unit by means of control signals. By virtue of the fact that at least two wheel brake control units are provided which are each assigned to a brake apparatus and are connected to a brake actuator, it is provided in other words that at least two brake apparatuses each have a dedicated wheel brake control unit which is connected to the central control unit and to the brake actuator.

Each wheel brake control unit can be actuated by the central control unit by way of setpoint brake values which are generated from a brake command which is received from the input apparatuses. A decentrally organized brake control system is realized by the advantageous combination of the central control unit with at least two decentral wheel brake control units which are assigned to the wheels. As a result, simpler and shorter wiring is enabled, in particular from a wheel sensor, in particular a wheel position sensor, in particular a wheel speed sensor, which is assigned to one wheel and can be connected directly to the wheel brake control unit of the brake apparatus which is likewise assigned to the wheel. As a result, the manufacturing and assembly complexity can be reduced in an advantageous way. Moreover, the sensitivity to external interference factors can be reduced. Furthermore, high redundancy can be realized by that the central configuration of the brake control system, with the result that the reliability can be increased further.

Here, a wheel brake control unit can preferably be of integrated configuration with the brake apparatus. A compact, reliable and assembly-friendly construction can be realized as a result. Each of the brake apparatuses preferably has a wheel brake control unit; for example, for wheel brake control units can correspondingly be provided in the case of a four-wheeled vehicle with four brake apparatuses or, in the case of a two-wheeled vehicle with two brake apparatuses, two wheel brake control units can correspondingly be provided.

It is preferred that a wheel brake control unit is connected in each case to at least one brake actuator. A wheel brake control unit ensures the actuation of the brake actuator or actuators by way of a defined setpoint control signal, in order to generate a defined brake torque for the wheel which is assigned to the respective brake apparatus.

It is advantageous that each of the wheel brake control units is connected to an electric actuating motor. The wheel brake control unit can actuate the actuating motor by way of electric setpoint control values of the control current. Two or more actuating motors of a brake apparatus can also be connected to one wheel brake control unit.

It can be provided, in particular, that each wheel brake control unit is connected to a sensor apparatus. The sensor apparatus can preferably comprise a wheel sensor, in particular a wheel speed sensor unit, which is assigned to the respective wheel to be braked. This can be configured so as to detect relevant parameters (actual values), in particular wheel position, wheel speed, vehicle speed and/or slip, and to forward them to the wheel brake control unit.

Furthermore, a sensor apparatus for detecting the electric current of the actuating motor, the brake force, and the like can be provided. Each of the brake apparatuses preferably has a sensor apparatus, preferably at least one wheel sensor, in particular a wheel speed sensor unit. One advantage is that the sensor unit, in particular a wheel speed sensor unit which is assigned to the respective brake unit, can be connected with relatively low complexity. The reliability and redundancy can be increased by virtue of the fact that relevant parameters can be measured at the wheel to be braked and can be forwarded to the wheel brake control unit without the central control unit being connected in between.

It can be provided that each wheel brake control unit has a regulating unit. The electric regulating unit advantageously compares the actual values of a wheel sensor or another sensor apparatus with the setpoint values of a brake demand which are transferred into the wheel brake control unit by the central control unit, and correspondingly actuates the actuating motor or motors of the brake actuator, in order to achieve the setpoint values.

In accordance with a further advantageous refinement of the brake system, the brake apparatus comprises an actuating apparatus and a brake part which is connected to the former, can be adjusted along an axis by the actuating apparatus, and can be brought into brake engagement with a counterbrake part, wherein the actuating apparatus has a first actuating drive and a second actuating drive which is coupled in series to the former, wherein the first actuating drive has a rotationally drivable first drive wheel, and the second actuating drive has a rotationally drivable second drive wheel which is coaxial with respect to the first drive wheel, wherein a clutch apparatus is arranged between the first drive wheel and the second drive wheel, wherein the clutch apparatus is preferably configured as a friction clutch with a friction element which, in clutch engagement, can be connected in a frictionally locking manner to a counterfriction element.

Further advantageous details, features and embodiment details of the invention will be explained in greater detail in conjunction with the exemplary embodiments which are shown in the figures, in which:

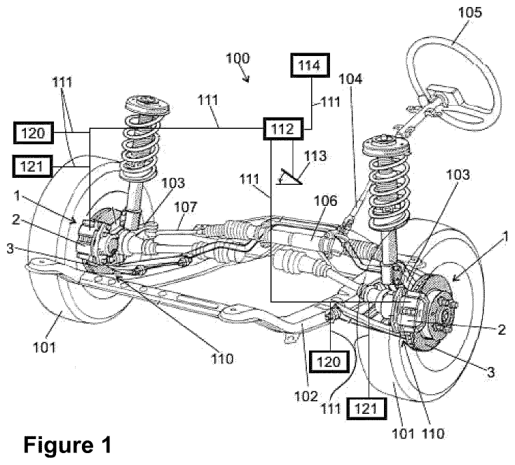

FIG. 1 shows one exemplary embodiment for a brake system configured according to the invention of a motor vehicle in a diagrammatically exposed illustration,

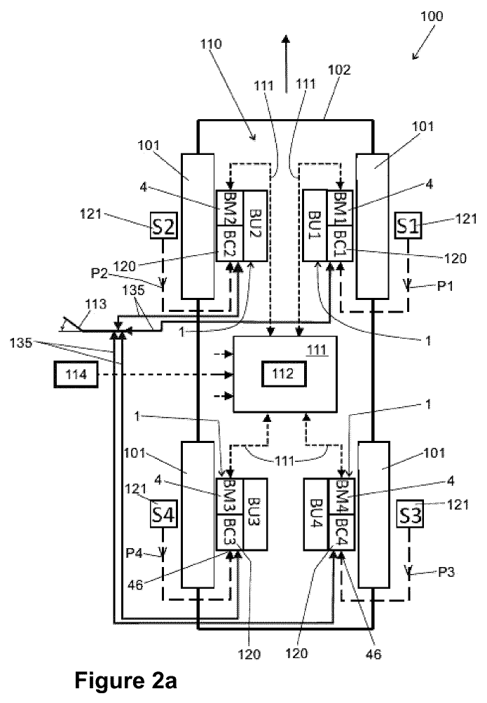

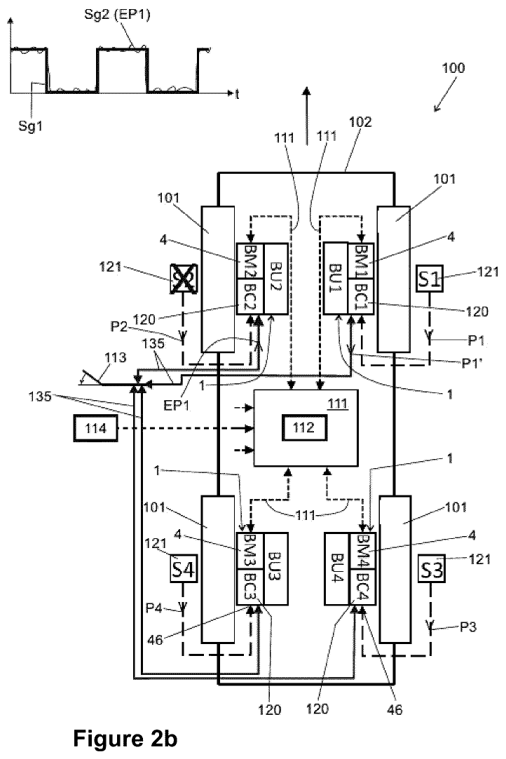

FIG. 2a shows a diagrammatic illustration of a further exemplary embodiment for a brake system configured according to the invention, in normal operation,

FIG. 2b shows a diagrammatic illustration of the exemplary embodiment for a brake system configured according to the invention in accordance with FIG. 2a, in the case of a disruption,

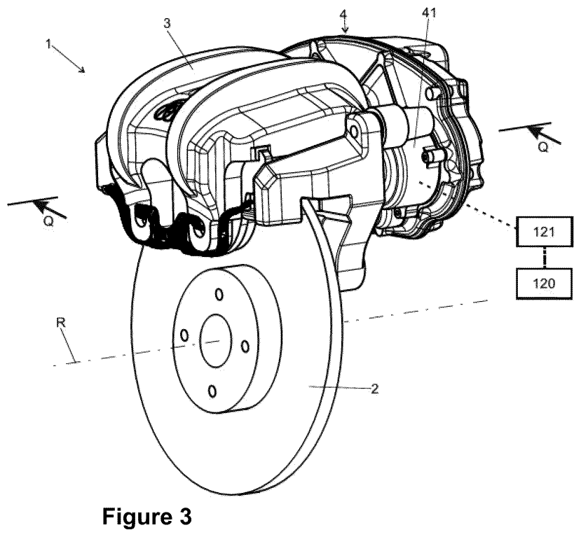

FIG. 3 shows a diagrammatic perspective view of one exemplary embodiment for a brake apparatus of a brake system configured according to the invention,

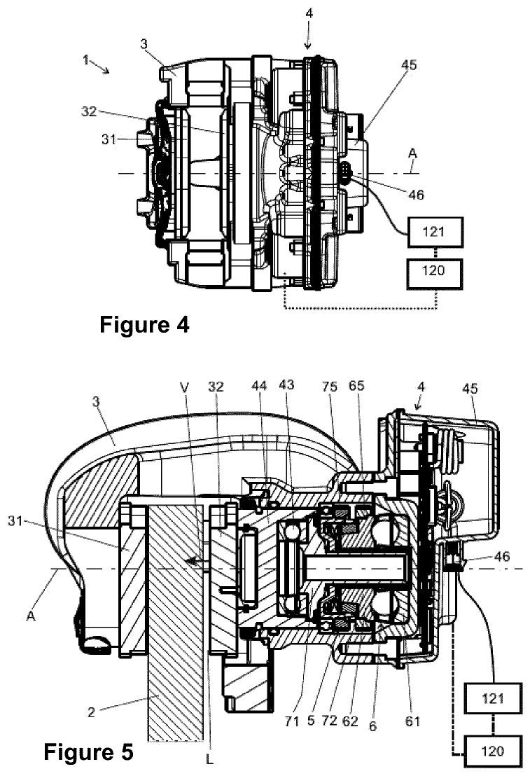

FIG. 4 shows a side view of the brake apparatus according to FIG. 3,

FIG. 5 shows a section Q-Q through the brake apparatus according to FIG. 3,

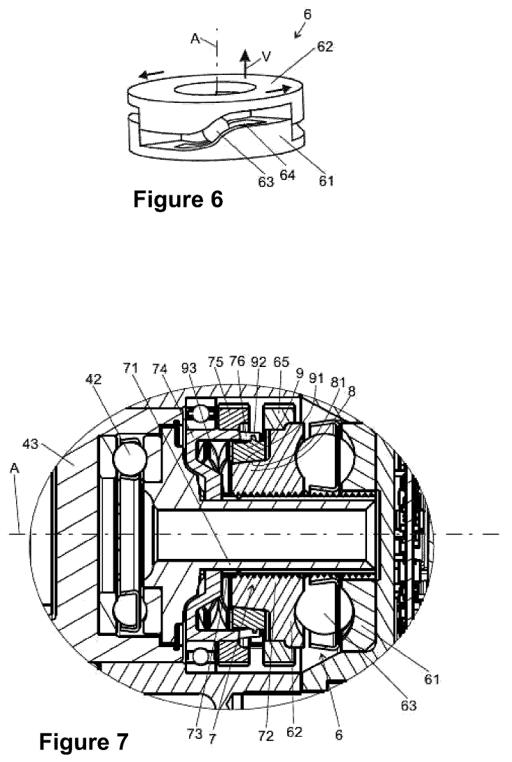

FIG. 6 shows a first actuating drive of the brake apparatus according to FIG. 3, exposed in a diagrammatic perspective illustration, and

FIG. 7 shows an enlarged detailed view of the actuating apparatus from FIG. 5.

In the different figures, identical parts are as a rule provided with the same designations and will therefore sometimes also be explained in each case only in conjunction with one of the figures.

FIG. 1 shows a diagrammatically exposed perspective partial illustration of the chassis 100 of a motor vehicle. This comprises steerable wheels 101 which are mounted on a frame part of the body 102 of the motor vehicle on pivotable steering knuckles 103. In this exemplary embodiment, a steering system of the motor vehicle comprises a steering shaft 104, to the rear end (in the direction of travel) of which a steering wheel 105 is attached as manual steering input means. The steering shaft 104 is connected to a steering gear 106 which is connected via track rods 107 to the steering knuckles 103 in order to generate a steering movement.

In this exemplary embodiment, an electromechanical brake system 110 of the motor vehicle has a brake pedal 113 which is attached to the body 102 and has an associated brake pedal sensor, wherein the brake pedal 113 is a manual input unit for transmitting a brake demand. The brake pedal 113 is shown merely diagrammatically in FIG. 1. In this exemplary embodiment, furthermore, the brake system 110 comprises an automated input unit 114 which is connected to a central control unit 112 of the brake system 110. This input unit 14 can output external control signals for controlling the brake system 110 to the central control unit 112.

Furthermore, the brake system 110 is shown in FIG. 1 comprises a brake apparatus 1 for each of the two wheels 101 shown in FIG. 1. This brake apparatus in each case has a brake caliper 3 which is attached to and supported on the motor vehicle body 102. A brake disk 2 is attached in each case as counterbrake part fixedly to a wheel 101 for conjoint rotation, which brake disk is engaged around by the brake caliper 3 which is stationary relative to it with brake linings (not shown explicitly here). Furthermore, the brake apparatuses 1 each have a brake actuator with an electric actuating motor, and the wheel brake control unit 120 for controlling the respective brake actuator. Each of the wheels 101 and therefore each of the brake apparatuses 1 are assigned a wheel speed sensor unit 121 which is configured to provide a wheel speed of the associated wheel 101 to the associated brake apparatus 1, which wheel speed is used by the wheel brake control unit 120 as the basis for the control of the respective brake actuator.

Furthermore, the wheel brake control unit 120 is configured to control the respective brake actuator on the basis of a provided substitute wheel speed, which is of advantage, in particular, when no wheel speed can be provided to the wheel brake control unit on account of a disruption in relation to the wheel speed sensor unit 121. Different possibilities are provided for the provision of the substitute wheel speed, which possibilities will also still in part be discussed in greater detail in the following text with reference to the further figures. In this regard, one variant provides that the wheel speeds provided by the wheel speed sensor units 121 are provided for retrieval via a data transmission system 111 of the motor vehicle, in particular via a CANbus of the motor vehicle. The wheel speed which is determined by the wheel speed sensor unit 121 which is assigned to the brake apparatus 1 on the right-hand side in FIG. 1 is thus provided via the data transmission system 111, for example, for a brake apparatus 1, shown on the left-hand side in FIG. 1, of the associated wheel brake control unit 120 as substitute wheel speed.

FIG. 2a and FIG. 2b each show a diagrammatic sketch of a chassis 100 with one exemplary embodiment for a brake system 110 configured according to the invention. The motor vehicle has four wheels 101 which are each assigned a brake apparatus 1 (BU1, BU2, BU3, BU4) of the brake system 110. In this exemplary embodiment, furthermore, the brake system 110 comprises a first input unit 113 and a second input unit 114 which can each transmit a brake demand for implementation by means of the brake apparatuses 1 (BU1, BU2, BU3, BU4) to the brake system 110. Here, in particular, the input unit 114 can be assigned to a driver assistance system, and can be connected in signal terms to the brake system 110 via a data transmission system 111, in particular a CANbus of the motor vehicle. In this exemplary embodiment, in contrast, the input unit 113 is a brake pedal or a brake pedal sensor which is assigned to the brake pedal and is configured, in particular, to detect an actuation of the brake pedal by a vehicle user and to transmit it as a brake demand via the communications links 135 which are sensor lines in this exemplary embodiment to the wheel brake control units 120 (BC1, BC2, BC3, BC4) of the brake system 110. In the case of actuation of the brake pedal, the brake pedal sensor 113 advantageously detects the brake pedal position, in particular in real-time, with the result that the respective wheel brake control unit 120 (BC1, BC2, BC3, BC4) can preferably also derive therefrom the acceleration of the brake pedal in the case of the actuation and can consider it for the control of the respective brake actuator 4 of the brake system 110.

In the exemplary embodiment which is shown in FIG. 2a and FIG. 2b, each of the four brake apparatuses 1 (BU1, BU2, BU3, BU4) each has a brake actuator 4 (BM1, BM2, BM3, BM4) and a wheel brake control unit 120 (BC1, BC2, BC3, BC4). A wheel speed sensor 121 (S1, S2, S3, S4) is connected in each case to the wheel brake control unit 120, which wheel speed sensor outputs actual values of the rotational position and wheel speed P1, P2, P3, P4 to the respective wheel brake control unit 120 (BC1, BC2, BC3, BC4) in real time during travel in normal operation which is shown in FIG. 2a. The respective wheel brake control unit 120 (BC1, BC2, BC3, BC4) is preferably of integrated configuration with the brake apparatus 1 and is connected electrically to the brake actuator 4 which in each case has electric actuating motors 41, 42, via which a brake engagement can be controlled.

Each of the total of four wheel brake control units 120 (BC1, BC2, BC3, BC4) can receive a wheel speed P1, P2, P3, P4 from the associated wheel speed sensor 121 in disruption-free normal operation, as shown in FIG. 2a. The wheel brake control unit BC1 can therefore receive a wheel speed P1 from the wheel speed sensor 121 (S1), for example, in disruption-free normal operation; the wheel brake control unit BC2 can receive a wheel speed P2 from the wheel speed sensor 121 (S2), etc. The wheel brake control unit BC1 then actuates the associated brake actuator 4 (BM1) with consideration of the wheel speed P1 provided by the associated wheel speed sensor unit 121 (S1) in normal operation in order to implement the brake demand transmitted by the input unit 113 or the input unit 114. Accordingly, the wheel brake control unit BC2 actuates the associated brake actuator 4 (BM2) with consideration of the wheel speed P2 provided by the associated wheel speed sensor unit 121 (S2) in normal operation in order to implement the transmitted brake demand. In the same way, the wheel brake control unit BC3 and BC4 actuate the associated brake actuators 4 (BM3) and 4 (BM4).

In this exemplary embodiment, however, it is not only provided that the wheel brake control units 120 (BC1, BC2, BC3, BC4) receive a brake demand from the input unit 113 via the respective communications link 135, wherein the brake demand is transmitted by the input unit 113 preferably as a first signal Sg1 in a first frequency range of the order of magnitude of 1 kHz. This is because it is additionally provided that the wheel brake control units 120 (BC1, BC2, BC3, BC4) comprise a modulation unit, by way of which the wheel brake control units 120 (BC1, BC2, BC3, BC4) provide a wheel speed P1, P2, P3, P4, received from the associated wheel speed sensor 121 (S1, S2, S3, S4), as a second signal Sg2 via the communications links 135 to in each case at least one of the other wheel brake control units 120 (BC1, BC2, BC3, BC4), in particular by the second signal Sg2 being modulated onto the first signal Sg1, which preferably takes place in a second frequency range of the order of magnitude of 100 kHz, and is shown diagrammatically in the diagram in FIG. 2b. It can be provided here, in particular, that the central control unit 112 specifies which of the wheel brake control units 120 (BC1, BC2, BC3, BC4) provides the received wheel speed P1, P2, P3, P4 as second signal Sg2 via the communications links 135 to the further wheel brake control units 120 (BC1, BC2, BC3, BC4) as substitute wheel speed EP1. It is thus to be provided in this exemplary embodiment that the wheel brake control unit BC1 provides a wheel speed P1, received from the associated wheel speed sensor unit S1, via the sensor lines 135 as a signal Sg2 (denoted as P1′ in FIG. 2b) to the further wheel brake control units BC2, BC3 and BC4 as substitute wheel speed EP1. Here, the assignment of transmitting and receiving wheel brake control units 120 can be changed by the central control unit 112, in particular can be varied cyclically. In particular, all detected wheel speeds can also be transmitted via the communications link 135, wherein different frequency bands are then preferably allocated to the wheel brake control units.

In normal operation which is shown in FIG. 2a, this substitute wheel speed EP1 can then be utilized, in particular, for diagnosis purposes, in particular for a comparison with the further detected wheel speeds P2, P3 and P4, in order to extrapolate a disruption of a sensor 121, for example, in the case of deviations which go beyond the tolerance threshold.

In the case where a disruption occurs in relation to one of the wheel speed sensors 121 or a signal line, via which a wheel speed sensor 121 transmits a wheel speed to the wheel brake control unit 120, the substitute wheel speed is used by the wheel brake control unit 120, however, instead of the wheel speed provided by the wheel speed sensor 121, in order to actuate the associated brake actuator 4 with consideration of the provided substitute wheel speed EP1. A disruption case of this type is outlined in FIG. 2b in relation to the wheel speed sensor 121 (S2). The wheel brake control unit BC2 therefore can no longer receive a wheel speed P2 from the wheel speed sensor 121 (S2). Instead, the wheel brake control unit BC2 demodulates the signal transmitted via the communications link 135 and, in this way, receives the wheel speed P1′ provided by the wheel brake control unit BC1 as substitute wheel speed EP1. The wheel brake control unit BC2 then controls the associated brake actuator 4 (BM2) with consideration of the received substitute wheel speed EP1. In addition, by way of example, FIG. 2b shows a first signal Sg1 as PWM signal for a brake demand with a second signal Sg2 modulated onto it for the substitute wheel speed EP1 in a diagram.

Furthermore, the wheel brake control units 120 (BC1, BC2, BC3, BC4) are advantageously configured in this exemplary embodiment to exchange signals with a central control unit 112 configured as an ECU, and to actuate the brake actuator 4 with consideration of further specifications by the central control unit 112. In accordance with a design variant which is not shown here, however, this central control unit 112 can also be omitted.

One advantageous embodiment of the brake actuator 4 is explained in further detail in the following text with reference to FIG. 3, FIG. 4 and FIG. 5. Here, a respective brake actuator 4 advantageously has a housing 45, in which the wheel brake control unit 120 is arranged, as can be seen in FIG. 5. This wheel brake control unit has an electric circuit which is connected to the actuating motors 41, 42 and the central control unit 112. As a result, the wheel brake control unit 120 is of integrated configuration with the brake apparatus 1.

In order to connect the wheel speed sensor 121 which is indicated diagrammatically in FIG. 2a and FIG. 2b and in FIG. 4 and FIG. 5, the brake actuator 4 has, in particular, a connector apparatus 46, in particular an electric plug-in connection which is arranged on the housing 45.

FIG. 3 shows one exemplary embodiment for a brake apparatus 1 of a brake system 110 configured according to the invention in its entirety, wherein the brake apparatus 1 is configured as a disk brake. It comprises a brake disk 2 which forms a counterbrake part and is connected to a vehicle wheel 101 (not shown here) which can be rotated about a wheel axis R. A brake caliper 3 engages around the two axial end surfaces of the brake disk 2. The brake disk 2 is configured here as a non-ventilated brake disk from solid material. As an alternative, it can also be configured as an internally ventilated brake disk.

A brake actuator 4 is attached to the brake caliper 3. The brake actuator 4 comprises an actuating apparatus 5 which extends axially in the direction of an axis A which lies parallel to the wheel axis R and specifies the adjustment direction V of the actuating apparatus 5. The brake actuator 4 comprises an electric actuating motor 41 which is assigned a wheel brake control unit 120. Here, the wheel brake control unit 120 is configured to determine a substitute wheel speed, based on vibrations of the brake disk 2, for a wheel speed which is measured by means of a wheel sensor unit 121. The fact is utilized here that the vibrations of the brake disk occur in a range between ±0.01 mm . . . 1 mm during operation as intended of the brake apparatus 1 in a traveling motor vehicle. On account of mechanical coupling via the very small air gap between the brake disk 2 and the brake lining which can lie in the range of tenths of a millimeter, these vibrations cause a ripple current in the actuating motor 41 of the brake apparatus 1. The mechanical coupling can be seen here, in particular, in FIG. 5. The wheel brake control unit 120 measures a current of the actuating motor 41 and/or the second actuating motor 42 which will still be explained in the following text, and in this regard can also detect the caused ripple current and evaluate it with regard to a wheel speed. It can be provided here that a wheel brake control unit 120 transmits a frequency of the detected ripple current and a wheel speed, determine by means of a wheel speed sensor unit 121 assigned to the brake apparatus 1, to a central control unit 112, as shown in FIG. 1 for example, wherein an artificial intelligence system of the central control unit 112 trains an assignment of the frequency of the ripple current to a corresponding wheel speed on the basis of the transmitted values. Then, in the case of a failure of the wheel speed sensor unit 121, a substitute wheel speed can advantageously be provided via the detected frequency of the ripple current of the wheel brake control unit 120, which substitute wheel speed can be used for the actuation of the actuating motor instead of the wheel speed from the wheel speed sensor unit 121 in order to implement a received brake demand.

FIG. 4 shows a view of the brake caliper 3 as viewed from the brake disk 2.

As can be seen in the sectional illustration of FIG. 5 along the axis A, the brake disk 2 is arranged axially between two brake linings 31 and 32. The one brake lining 31 is supported fixedly on the brake caliper 3 on the side which faces away from the brake actuator 4. The other brake lining 32 which forms a brake part of the brake apparatus 1 is attached to the actuating apparatus 5 and can be adjusted by the latter in the axial adjustment direction V (indicated by the axis A) toward the brake disk 2 in order to generate the brake engagement, as is indicated by the arrow in FIG. 5.

In the non-actuated state of the brake apparatus 1, the axial air gap L which has already been addressed and is shown with an exaggerated width diagrammatically in FIG. 5 is situated between the brake disk 2 and the adjustable brake lining 32.

The construction of the actuating apparatus 5 is shown in FIG. 5 and in the enlarged detailed therefrom in FIG. 7. The actuating apparatus 5 comprises a first actuating drive 6 which has a ramp bearing, and a second actuating drive 7 which is coupled axially (with regard to the axis A) in series to the former and has a spindle drive.

The first actuating drive 6 which is configured as a ramp bearing in the example which is shown comprises a drive-side cam disk 61 which is supported fixedly on the brake actuator 4 for conjoint rotation, and an output-side cam disk 62. Balls 63 are arranged between the cam disks 61 and 62. As can be seen in the diagrammatically exposed view of FIG. 6, the cam disks 61 and 62 have ramp-like raceways 64 which lie axially opposite one another, lie obliquely with respect to the axis A, and between which balls 63 can roll. A rotation of the output-side cam disk 62 (at the top in FIG. 6) relative to the stationary drive-side cam disk 61 (as indicated diagrammatically by the curved arrows) leads to a linear adjustment of the output-side cam disk 62 in the adjustment direction V parallel to the axis A. As a result, as shown in FIG. 5, the brake lining 32 can be brought into brake engagement by actuation of the first actuating drive 6.

The cam disk 62 is connected to a coaxial gearwheel 65 which is configured as a spur gear and forms a drive wheel within the context of the invention. The gearwheel 65 is in geared engagement with a first electric actuating motor 41. This makes the rotational drive of the cam disk 62 and therefore an actuation of the first actuating drive 6 possible. The second actuating drive 7 which is configured as a spindle drive in the example which is shown has, on the output side, a threaded spindle 71 which engages into the internal thread of a drive-side spindle nut 72. This internal thread is configured in the output-side cam disk 62 of the first actuating drive 6, with the result that the functions of the output-side cam disk 62 and the drive-side spindle nut 72 are combined in one structural unit.

The threaded spindle 71 is connected via a hub part 74 to a coaxial gearwheel 75 which is mounted rotatably in the brake actuator 4 in an axially fixed manner. Via drivers 73 which can have, for example, radially projecting projections or teeth which engage axially displaceably into axial slots of the hub part 74, the threaded spindle is coupled to the gearwheel 75 in a torque-transmitting but axially movable manner.

Like the gearwheel 65, the gearwheel 75 can be configured as a spur gear and is arranged coaxially adjacently with respect thereto. This gearwheel 75 is in geared engagement with a second electric actuating motor 42. This makes the rotational drive of the threaded spindle 71 and therefore an actuation of the second actuating drive 7 possible. The threaded spindle 71 is connected axially via a thrust bearing 43, for example an axial antifriction bearing as shown, to a pressure piece 44, to which the movable brake lining 32 is attached, as can be seen in FIG. 5. The pressure piece 44 can also be called a piston.

The clutch apparatus according to the invention has a friction element 8 which is directed onto the second actuating drive 7 as a coaxial, conical attachment from the cam disk 62. The conical attachment has a conical friction surface 81 which is arranged on the outside on an outer cone. The friction element 81 can preferably be configured in one piece with the cam disk 62/spindle nut 72.

The friction element 8 is coupled in clutch engagement in a frictionally locking manner to a counterfriction element 9. Here, the conical attachment dips axially into a corresponding conical opening of the counterfriction element 9 which has a conical friction surface 91 which is arranged in an inner cone. In the clutch engagement, the friction surface 81 and the counterfriction surface 91 lie against one another in a frictionally locking manner, as can be seen clearly in FIG. 7. The counterfriction element 9 is coupled to the gearwheel 75 in a torque-transmitting but axially movable manner via drivers 92 which engage in an axially displaceable manner into corresponding slots 76 in the hub part 74 or the gearwheel 75.

A spring element 93 is arranged between the gearwheel 75, or the hub part 74 which is connected to it, and the counterfriction element 9. The counterfriction element 9 is braced elastically against the friction 8 via its axially acting spring force. As a result, a defined clutch torque of the friction clutch which is formed by the friction element 8 and the counterfriction element 9 is generated.

In order to actuate the brake apparatus 1, the gearwheels 65 and 75 are rotated synchronously, with the result that the first actuating drive 6 performs a working stroke in the adjustment direction V, with the result that the brake lining 32 passes the air gap L and comes into brake engagement with the brake disk 2. The synchronous drive of the gearwheels 65 and 75 can be brought about by a synchronization of the drive speeds of the actuating motors 41 and 42, or by the drive by way of only one of the actuating motors 41 or 42 while the respective other actuating motor 42 or 41 runs idly with it. The frictionally locking clutch engagement between the friction element 8 and the counterfriction element 9 then ensures a synchronous rotation of the gearwheels 65 and 75. A particularly compact overall design can be realized by virtue of the fact that the friction element 8 and the counterfriction element 9 are arranged completely or at least partially within the gearwheels 65 and 75.

In order to adjust the width of the air gap L, the gearwheel 65 is locked or blocked, in particular by a corresponding actuation of the first actuating motor 41. The gearwheel 75 is rotated relative to the gearwheel 65 by the second actuating motor 42, wherein the friction clutch slips continuously in a sliding manner. Accordingly, the second actuating drive 7 is adjusted uniformly, as a result of which the width of the air gap L can likewise be set and adapted continuously, in order to compensate for wear of the brake lining 32, for example.

The brake apparatuses shown in FIG. 3 to FIG. 7 are configured as a floating caliper brake (also called a sliding caliper brake). Here, the brake lining 32 is pressed onto the brake disk 2 by the pressure piece 44, and the brake lining 31 is pressed by the brake caliper 3, which is displaceable in the direction of the axis A with respect to the brake disk 2. As an alternative, the proposed solution can also be used in the case of a fixed caliper brake.

The exemplary embodiments which are shown in the figures and are explained in conjunction with them serve to explain the invention and do not restrict the invention.

### LIST OF DESIGNATIONS

1 Brake apparatus (BU1, BU2, BU3, BU4)
100 Chassis
101 Wheel (vehicle wheel)
102 Vehicle body
103 Steering knuckle
104 Steering shaft
105 Steering wheel
106 Steering gear
107 Track rod
110 Brake system
111 Data transmission system
112 Central control unit
113 Brake pedal (input unit)
114 Input unit
120 Wheel brake control unit (BC1, BC2, BC3, BC4)
121 Wheel speed sensor unit (S1, S2, S3, S4)
135 Communications link
2 Brake disk (counter-brake part)
3 Brake caliper
31, 32 Brake lining (Brake part)
4 Brake actuator (BM1, BM2, BM3, BM4)
41, 42 Actuating motor
43 Thrust bearing
44 Pressure piece
45 Housing
46 Connector apparatus
5 Actuating apparatus
6 First actuating drive
61 Cam disk
62 Cam disk (integrated with spindle nut 72)
63 Ball
64 Raceway
65 Gearwheel (first drive wheel)
7 Second actuating drive
71 Threaded spindle
72 Spindle nut (integrated with cam disk 62)
73 Driver
74 Hub part
75 Gearwheel (second drive wheel)
76 Slot
8 Friction element
81 Friction surface
9 Counterfriction element
91 Counterfriction surface
92 Driver
93 Spring element
P1, P2, Wheel speed
P3, P4
P1′ Wheel speed forwarded by a wheel brake control unit (BC1)
EP1 Substitute wheel speed
A Axis
R Wheel axle
V Adjusting direction
L Air gap
Sg1 First signal
Sg2 Second signal

1-17. (canceled)

18. A method for operating an electromechanical brake system in a motor vehicle, wherein the brake system has at least one input unit, via which a brake demand is transmitted, and at least two brake apparatuses which each comprise a brake actuator with at least one electric actuating motor, wherein the brake apparatuses are each assigned a wheel brake control unit and a wheel speed sensor unit, the method comprising:
providing, by the associated wheel speed sensor unit of the associated wheel brake control unit, a wheel speed for a respective brake apparatus;
providing a substitute wheel speed, for the wheel speed which is provided by the associated wheel speed sensor unit, to this wheel brake control unit;
actuating, by this wheel brake control unit, the brake actuator in normal operation in order to implement the transmitted brake demand, with consideration of the wheel speed which is provided by the associated wheel speed sensor unit; and
actuating, by the wheel brake control unit, the brake actuator with consideration of the provided substitute wheel speed in order to implement the transmitted brake demand in the case of a disruption in relation to the provision of the wheel speed by the associated wheel speed sensor unit.

19. The method as claimed in claim 18, wherein the wheel brake control units are connected to one another via a data transmission system for the exchange of data, wherein a wheel speed is provided as substitute wheel speed via the data transmission system to the wheel brake control unit, which is assigned to a brake apparatus, by at least one of the wheel speed sensor units which is not assigned directly to this brake apparatus.

20. The method as claimed in claim 18, wherein the input unit of the brake system is connected to the respective wheel brake control units via a communications link in order to transmit the brake demand, wherein, as substitute wheel speed, the wheel speed which is provided by one of the further wheel brake control units is provided via the communications link by this wheel brake control unit to the wheel brake control unit which is assigned to a brake apparatus.

21. The method as claimed in claim 20, wherein the brake demand is transmitted in a first frequency range via the communications link, and the substitute wheel speed is transmitted in a second frequency range via the communications link, wherein the second frequency range is a frequency range which differs from the first frequency range.

22. The method as claimed in claim 20, wherein the brake demand is transmitted as a first signal via the communications link to the wheel brake control units, and the substitute wheel speed is transmitted via the communications link as a second signal which is modulated onto the first signal.

23. The method as claimed in claim 22, wherein the respective wheel brake control unit which provides the substitute wheel speed modulates the substitute wheel speed as the second signal, and the receiving wheel brake control unit demodulates the second signal.

24. The method as claimed in claim 18, wherein the input unit is a brake pedal sensor which transmits a brake pedal position as brake demand in an analog or digital manner.

25. The method as claimed in claim 18, wherein at least one of the brake apparatuses comprises a brake disk, wherein the wheel brake control units which are assigned to a brake apparatus of this type with a brake disk determine the substitute wheel speed or a further substitute wheel speed based on vibrations of the brake disk.

26. The method as claimed in claim 25, wherein the wheel brake control unit which is assigned to a brake apparatus with a brake disk detects a ripple current which is brought about by vibrations of the brake disk and on account of mechanical coupling in the at least one actuating motor of the brake apparatus, and defines the substitute wheel speed or the further substitute wheel speed based on the detected ripple current.

27. The method as claimed in claim 26, wherein, during normal operation, an artificial intelligence system trains the determination of the substitute wheel speed or the further substitute wheel speed based on the ripple current detected for a brake apparatus, with consideration of the wheel speed which is provided by the wheel speed sensor unit which is assigned to this brake apparatus.

28. The method as claimed in claim 18, wherein the brake apparatuses are connected to a central control unit which is configured for connection to the at least one input unit, wherein a brake demand is input by at least one of the input units into the central control unit which actuates the brake actuators by way of control signals, wherein the central control unit outputs control signals to at least two wheel brake control units which are each assigned to a brake apparatus and each actuate a brake actuator of the respective brake apparatus.

29. The method as claimed in claim 18, wherein the brake apparatus has an actuating apparatus which can be coupled to the at least one actuating motor and comprises a first actuating drive and a second actuating drive which is connected in series to the former, and which acts on a brake part which can be brought into brake engagement with a counterbrake part in the direction of an axis, wherein the first actuating drive has a rotationally drivable first drive wheel, to which a first drive torque can be applied for actuation purposes, and the second actuating drive has a rotationally drivable second drive wheel which is coaxial with respect to the first drive wheel and to which a second drive torque can be applied for actuation purposes, wherein a clutch apparatus is arranged between the first drive wheel and the second drive wheel.

30. The method as claimed in claim 29, wherein the clutch apparatus is configured as a friction clutch and has a predefinable clutch torque, upon the exceeding of which the first drive wheel slips in a sliding manner relative to the second drive wheel, wherein the first drive wheel and the second drive wheel are driven synchronously in order to actuate the first actuating drive, with the result that the second actuating drive remains non-actuated, and, in order to actuate the second actuating drive, the second drive wheel is driven, and the first drive wheel is at a standstill relative to the former, with the result that the friction clutch slips and the first actuating drive remains non-actuated.

31. A brake system for a motor vehicle, comprising:
at least one input unit for transmitting a brake demand; and
at least two brake apparatuses which are each assigned a wheel speed sensor unit which is configured to provide a wheel speed to the associated brake apparatus;
wherein the brake apparatuses each comprise a brake actuator which has at least one electric actuating motor;
wherein the brake apparatuses are each assigned a wheel brake control unit for controlling the respective brake actuator;
wherein the wheel brake control unit is configured to control the brake actuator with consideration of the wheel speed which is provided by the associated wheel speed sensor unit, and is configured, furthermore, to control the brake actuator with consideration of a substitute wheel speed for the wheel speed which is provided by the associated wheel speed sensor unit.

32. The brake system as claimed in claim 31, wherein the brake apparatuses are connected to a central control unit which is configured for connection to the at least one input unit, and the wheel brake control units are connected to the central control unit.

33. The brake system as claimed in claim 31, wherein the brake apparatus comprises an actuating apparatus and a brake part which is connected to the former, can be adjusted along an axis by the actuating apparatus, and can be brought into brake engagement with a counterbrake part, wherein the actuating apparatus has a first actuating drive and a second actuating drive which is coupled in series to the former, wherein the first actuating drive has a rotationally drivable first drive wheel, and the second actuating drive has a rotationally drivable second drive wheel which is coaxial with respect to the first drive wheel, wherein a clutch apparatus is arranged between the first drive wheel and the second drive wheel, wherein the clutch apparatus is preferably configured as a friction clutch with a friction element which, in clutch engagement, can be connected in a frictionally locking manner to a counterfriction element.
